(19) United States
(12) Patent Application Publication
(10) Pub. No.: US 2013/0235409 A1
(43) Pub. Date: Sep. 12, 2013

(54) NON-TRANSITORY COMPUTER-READABLE MEDIUM STORING IMAGE PROCESSING PROGRAM AND NON-TRANSITORY COMPUTER-READABLE MEDIUM STORING IMAGE OUTPUT PROGRAM

(71) Applicant: Yuji MIYATA, Kitanagoya-shi (JP)

(72) Inventor: Yuji MIYATA, Kitanagoya-shi (JP)

(73) Assignee: Brother Kogyo Kabushiki Kaisha, Nagoya-shi (JP)

(21) Appl. No.: 13/791,353

(22) Filed: Mar. 8, 2013

(30) Foreign Application Priority Data
Mar. 9, 2012 (JP) 2012-052595

(51) Int. Cl. H04N 1/23

(52) U.S. Cl. CPC H04N 1/233
USPC 358/1.13

(57) ABSTRACT

A non-transitory medium storing an image processing program causing a computer of an image-data processing device to function as: an image-data obtaining unit which obtains image data respectively corresponding to successive pages; a processing unit which, when one image data is blank-sheet data, and each of two image data just before and after the one image data is not the blank-sheet data, establishes a state in which the storage device stores output command data for commanding the output device to output a blank-sheet image corresponding to the one image data; and another processing unit which, when one image data and data just before or after the one image data are blank-sheet data, establishes a state in which the storage device does not store the output command data for commanding the output device to output a blank-sheet image corresponding to the one image data.

### CROSS REFERENCE TO RELATED APPLICATION

The present application claims priority from Japanese Patent Application No. 2012-052595, which was filed on Mar. 9, 2012, the disclosure of which is herein incorporated by reference in its entirety.

### BACKGROUND OF THE INVENTION

1. Field of the Invention

The present invention relates to a non-transitory computer-readable medium storing an image processing program and a non-transitory computer-readable medium storing an image output program.

2. Description of the Related Art

There has been developed a technique of obtaining a plurality of image data respectively corresponding to a plurality of pages of a bound printed material by, e.g., scanning and then controlling an output device to output images based on the plurality of image data. When the obtained image data is blank-sheet data in such a technique, it is undesirable that an image based on the blank-sheet data is output by the output device. In light of the above, there is another technique in which when the obtained image data is the blank-sheet data, the obtained blank-sheet data is deleted so as for the output device not to output the image based on the blank-sheet data.

### SUMMARY OF THE INVENTION

In the above-described technique, the output device does not output the image based on the blank-sheet data, eliminating unnecessary image output and unnecessary data storing. However, there is an undesirable situation that occurs if all the blank-sheet data are deleted when an image representative of a plurality of pages is output by the output device. For example, when a bound printed material is constituted by a plurality of pages, and the output device outputs a pair of right and left pages of the bound printed material at a time in a two-page spread layout, these pair of right and left pages may not be output appropriately. Specifically, consider a case where a map, a picture, or other similar image is illustrated on a pair of right and left pages of the bound printed material (see FIG. 5A), that is, one image is formed by images illustrated on the respective right and left pages, for example. In this case, if a page prior to these right and left pages is deleted, the right and left pages may not be output at a time (see FIG. 5B), resulting in failure to create the original image.

This invention has been developed to provide a technique capable of reducing output of an image based on blank-sheet data and capable of appropriately controlling an output device to output images even in a two-page spread layout.

The present invention provides a non-transitory computer-readable medium storing an image processing program executable by a computer of an image-data processing device configured to process image data to be used for an output device configured to output an image, the image processing program being designed to cause the computer to function as: an image-data obtaining unit configured to obtain a plurality of image data respectively corresponding to a plurality of successive pages, the plurality of image data comprising one image data and two image data respectively prior to and subsequent to the one image data successively; a first processing unit configured, when the one image data obtained by the image-data obtaining unit is not blank-sheet data, to establish a state in which a storage device stores one of the one image data and another image data, wherein said another image data is image data based on which the output device outputs an image equivalent or similar to an image output by the output device based on the one image data; a second processing unit configured, when the one image data of the plurality of image data obtained by the image-data obtaining unit is the blank-sheet data and when each of the two image data respectively prior to and subsequent to the one image data successively is not the blank-sheet data, to establish a state in which the storage device stores output command data for commanding the output device to output a blank-sheet image as an image corresponding to the one image data; and a third processing unit configured, when the one image data of the plurality of image data obtained by the image-data obtaining unit is the blank-sheet data and when one successive image data that is one of the two image data respectively prior to and subsequent to the one image data successively is the blank-sheet data, to establish a state in which the storage device does not store the output command data for commanding the output device to output the blank-sheet image as the image corresponding to the one image data.

The present invention also provides a non-transitory computer-readable medium storing an image processing program executable by a computer of an image-data processing device configured to process image data to be used for an output device configured to output an image, the image processing program being designed to cause the computer to function as: an image-data obtaining unit configured to obtain a plurality of image data respectively corresponding to a plurality of successive pages, the plurality of image data comprising one image data and two image data respectively prior to and subsequent to the one image data successively; a first processing unit configured, when the one image data of the plurality of image data obtained by the image-data obtaining unit is not blank-sheet data, to establish a state in which a storage device stores one of the one image data and another image data, wherein said another image data is image data based on which the output device outputs an image equivalent or similar to an image output by the output device based on the one image data; a second processing unit configured, when the one image data of the plurality of image data obtained by the image-data obtaining unit is the blank-sheet data and when each of the two image data respectively prior to and subsequent to the one image data successively is not the blank-sheet data, to establish a state in which the storage device stores output command data for commanding the output device to output a blank-sheet image as an image corresponding to the one image data; and a non-output-command storing unit configured, when the one image data of the plurality of image data obtained by the image-data obtaining unit is the blank-sheet data and when one successive image data that is one of the two image data respectively prior to and subsequent to the one image data successively is the blank-sheet data, to establish a state in which the storage device stores a non-output command data for commanding the output device not to output the blank-sheet image as the image corresponding to the one image data.

The present invention also provides a non-transitory computer-readable medium storing an image output program executable by a computer of an output device comprising an output unit configured to output an image based on one of a plurality of image data processed by an image-data processing device, the plurality of image data comprising one image data and two image data respectively prior to and subsequent to the one image data successively, the image output program being designed to cause the computer to function as: a first output control unit configured, when the one image data of the plurality of image data processed by the image-data processing device is not blank-sheet data, to control the output unit to output an image based on the one image data; a second output control unit configured, when the one image data of the plurality of image data processed by the image-data processing device is the blank-sheet data and when each of the two image data respectively prior to and subsequent to the one image data successively is not the blank-sheet data, to control the output unit to output a blank-sheet image as an image corresponding to the one image data; and a third output control unit configured, when the one image data of the plurality of image data processed by the image-data processing device is the blank-sheet data and when one successive image data that is one of the two image data is the blank-sheet data, to control the output unit not to output the blank-sheet image as the image corresponding to the one image data.

The present invention also provides a non-transitory computer-readable medium storing an image processing program executable by a computer of an image-data processing device configured to process image data to be used for an output device configured to output an image, the image processing program being designed to cause the computer to function as: an image-file obtaining unit configured to obtain a first image file comprising a plurality of image data respectively corresponding to a plurality of successive pages; and an image-file storing unit configured to store a second image file into a storage device, wherein the second image file comprises one of first image data of the plurality of image data of the first image file obtained by the image-file obtaining unit and another image data based on which the output device outputs an image equivalent or similar to an image output by the output device based on the first image data, wherein the first image data is not the blank-sheet data, wherein the second image file further comprises: one of second image data of the plurality of image data of the first image file obtained by the image-file obtaining unit and output command data, wherein the second image data is the blank-sheet data, and image data successive to the second image data is not the blank-sheet data, and wherein the output command data is data based on which the output device outputs a blank-sheet image equivalent or similar to a blank-sheet image output by the output device based on the second image data, and wherein the second image file does not comprise: third image data of the plurality of image data of the first image file obtained by the image-file obtaining unit or another output command data, wherein the third image data is the blank-sheet data, and image data successive to the third image data is the blank-sheet data, and wherein the said another output command data is data based on which the output device outputs a blank-sheet image equivalent or similar to a blank-sheet image output by the output device based on the third image data.

### BRIEF DESCRIPTION OF THE DRAWINGS

The objects, features, advantages, and technical and industrial significance of the present invention will be better understood by reading the following detailed description of the embodiments of the invention, when considered in connection with the accompanying drawings, in which:

FIG. 1 is a block diagram illustrating a communication system 1;

FIG. 2 is a flow chart illustrating operations of an MFP 50;

FIG. 3 is a flow chart illustrating operations of a mobile phone 10;

FIG. 4 is a flow chart illustrating operations of the mobile phone 10;

FIGS. 5A-5C are views each illustrating an example of display aspects of images displayed on a panel 22 of a mobile phone 10;

FIG. 6 is a view conceptually illustrating an information amount of each image file stored in an image-file storage area 14a of the mobile phone 10;

FIG. 7 is a flow chart illustrating operations of the MFP 50;

FIG. 8 is a flow chart illustrating operations of the mobile phone 10;

FIG. 9 is a flow chart illustrating operations of the MFP 50; and

FIG. 10 is a flow chart illustrating operations of the mobile phone 10.

### DETAILED DESCRIPTION OF THE EMBODIMENTS

### First Embodiment

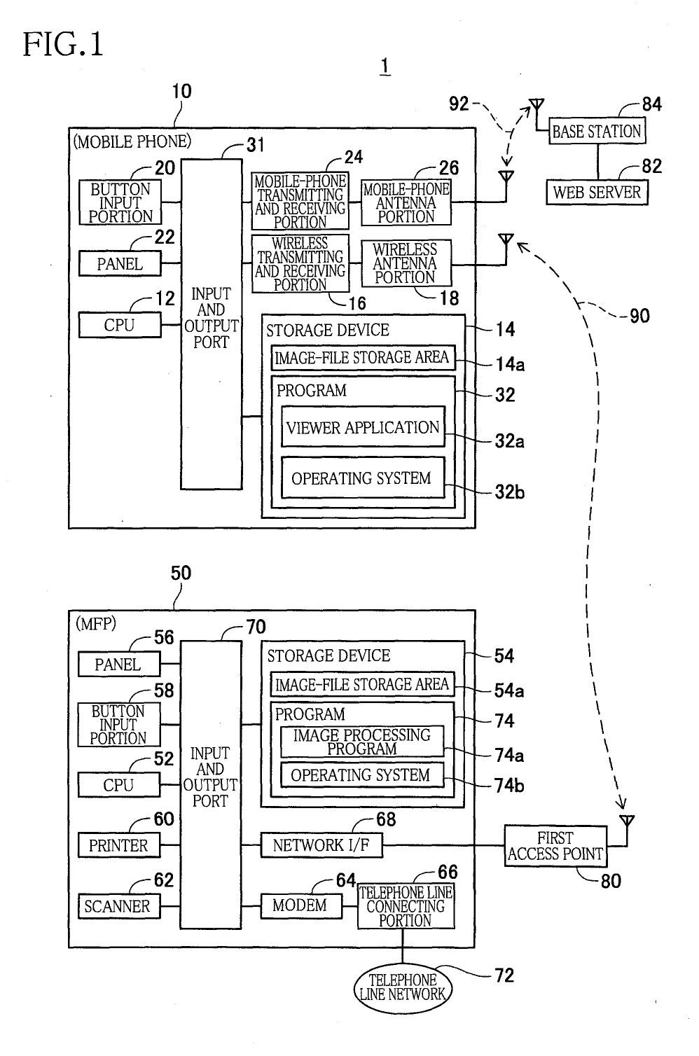

Hereinafter, there will be described embodiments of the present invention by reference to the drawings. FIG. 1 illustrates a communication system 1 in a first embodiment of the present invention. The communication system 1 includes a mobile phone 10, a multi-function peripheral (hereinafter referred to as “MFP”) 50, a first access point 80, a web server 82, and a base station 84. Each of the mobile phone 10 and the MFP 50 can act as a well-known wireless-LAN terminal device. The MFP 50 has various functions such as a printing function, a scanning function, a copying function, and a facsimile function. The first access point 80 can act as a well-known wireless-LAN access point. The web server 82 is a device which delivers its functions and data to client devices through a network.

It is noted that the mobile phone 10 and the first access point 80 can perform wireless communication 90, i.e., data communication using radio waves, by utilizing a wireless LAN operating in Infrastructure mode that uses access points for data communication between a plurality of wireless-LAN terminal devices. That is, when the mobile phone 10 accesses the first access point 80 and becomes able to perform the wireless communication 90 in the Infrastructure mode, the mobile phone 10 can perform data communication with the MFP 50 via the first access point 80. It is noted that examples of the type of the wireless LAN include communication methods according to IEEE802.11a/b/g/n standards.

There will be next explained a structure of the MFP 50. The MFP 50 mainly includes a central processing unit (hereinafter referred to as “CPU”) 52, a storage device 54, a panel 56, a button input portion 58, a printer 60, a scanner 62, a modem 64, a telephone line connecting portion 66, and a network I/F 68. These devices and components can communicate with one another via an input and output port 70.

The panel 56 is designed to display the functions of the MFP 50 thereon. The button input portion 58 is constituted by a plurality of keys for executing the functions of the MFP 50. This button input portion 58 may be provided integrally with the panel 56 as a touch panel. The printer 60 is designed to perform printing. The modem 64 is designed to convert document data into a signal transmittable to a telephone line network 72, and transmit the signal to the telephone line network 72 via the telephone line connecting portion 66 using the facsimile function. The modem 64 is also designed to receive a signal from the telephone line network 72 via the telephone line connecting portion 66 to decode the signal into document data. The network I/F 68 is connected to the first access point 80 to perform data communication with the mobile phone 10 via the first access point 80.

The scanner 62 is designed to scan one by one a plurality of pages of documents placed on a document table, not shown, to create an image file. One image file contains a plurality of image data, each of which is representative of a corresponding one of images to be displayed. That is, images obtained by the scanning of the plurality of pages of the documents are images represented by the respective image data contained in the image file. In the following explanation, “the images represented by the respective image data contained in the image file” may be referred to as “images contained in the image file”. Also, the term “image data item” or “image data element” can be used to indicate image data representative of a certain page in the present embodiment.

The CPU 52 executes processings according to one or more of programs 74 stored in the storage device 54. Hereinafter, the CPU 52 that executes programs such as an image processing program 74a and an operating system 74b may be simply referred to as the name of the program. For example, the wording “the image processing program 74a executes” may mean “the CPU 52 that executes the image processing program 74a executes”. It is noted that the storage device 54 is constituted by various components including: a random access memory, or RAM; a read only memory, or ROM; a flash memory; a hard disc, or HDD; and a buffer of the CPU 52.

The storage device 54 stores the programs 74 therein. The programs 74 include the image processing program 74a and the operating system 74b. The image processing program 74a is a program that causes the CPU 52 to execute processings which will be described below for the image file obtained by the scanner 62. The operating system 74b is a program that provides basic functions commonly used by the image processing program 74a. The operating system 74b includes a program that causes the network I/F 68 to perform communication.

The storage device 54 has an image-file storage area 54a. The image-file storage area 54a stores various data and files such as the image file obtained by the scanner 62 and the image file for which the processings which will be described below have been executed according to the image processing program 74a.

There will be next explained a structure of the mobile phone 10. The mobile phone 10 mainly includes a CPU 12, a storage device 14, a wireless transmitting and receiving portion 16, a wireless antenna portion 18, a button input portion 20, a panel 22, a mobile-phone transmitting and receiving portion 24, and a mobile-phone antenna portion 26. These devices and components can communicate with one another via an input and output port 31.

The CPU 12 executes processings according to one or more of programs 32 stored in the storage device 14. Hereinafter, the CPU 12 that executes programs such as a viewer application 32a and an operating system 32b may be simply referred to as the name of the program. For example, the wording “the viewer application 32a executes” may mean “the CPU 12 that executes the viewer application 32a executes”. It is noted that the storage device 14 is constituted by various components including a RAM, a ROM, a flash memory, an HDD, and a buffer of the CPU 12.

The wireless transmitting and receiving portion 16 performs the wireless communication 90 operating in the Infrastructure mode via the wireless antenna portion 18. The mobile-phone transmitting and receiving portion 24 performs wireless communication 92 with the base station 84 via the mobile-phone antenna portion 26 according to a communication method of the mobile phone. The wireless transmitting and receiving portion 16, the mobile-phone transmitting and receiving portion 24, and other communication components transmit and receive digital signals constituting various data.

The storage device 14 stores the programs 32 therein. The programs 32 include the viewer application 32a and the operating system 32b. The viewer application 32a is an application that causes the CPU 12 to display, on the panel 22, an image or images represented by image data stored in an image-file storage area 14a. The operating system 32b is a program that provides basic functions commonly used by the viewer application 32a. The operating system 32b includes: a program that causes the mobile-phone transmitting and receiving portion 24 to perform telephone communication; and a program that causes the wireless transmitting and receiving portion 16 to perform the wireless communication 90.

The storage device 14 has the image-file storage area 14a. The image-file storage area 14a stores a plurality of image files. Examples of the image files include an image file created based on a plurality of documents scanned by the scanner 62 of the MFP 50. Such an image file created by the MFP 50 is transmitted to the first access point 80 and then transmitted to the wireless transmitting and receiving portion 16 via the wireless antenna portion 18 by the wireless communication 90 operating in the Infrastructure mode. After received by the wireless transmitting and receiving portion 16, the image file is stored into the image-file storage area 14a of the storage device 14.

The panel 22 is designed to display various functions of the mobile phone 10 thereon. The button input portion 20 is constituted by a plurality of keys for executing the functions of the mobile phone 10. This button input portion 20 may be provided integrally with the panel 22 as a touch panel.

<Operations of MFP>

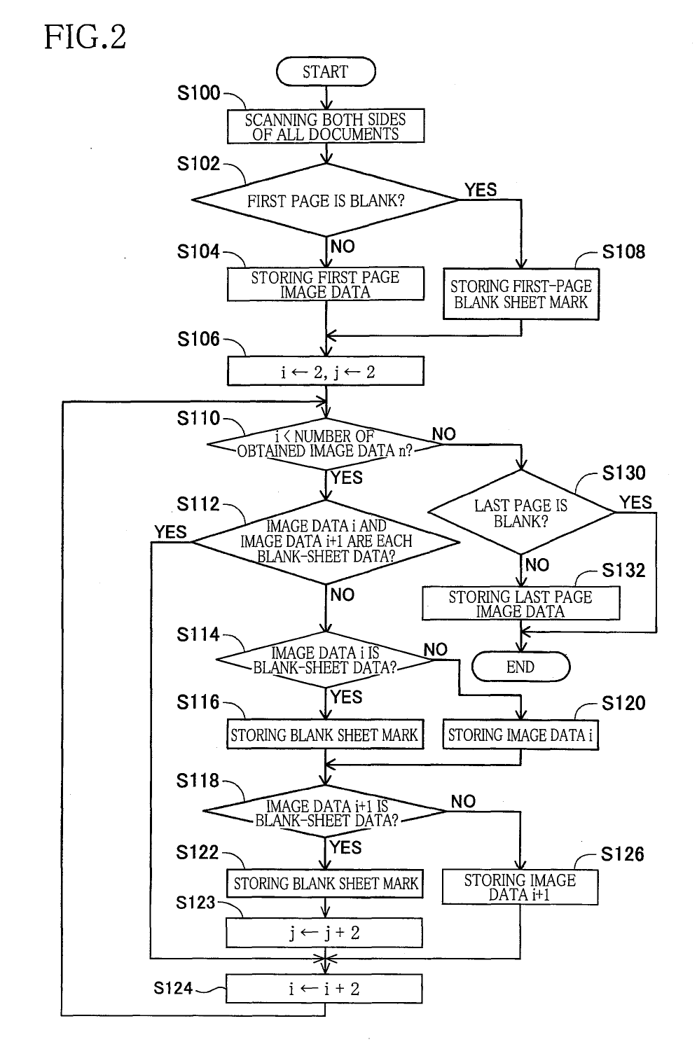

There will be next explained operations of the MFP 50 in the first embodiment. The MFP 50 uses the image processing program 74a to execute processings for image data created by the scanner 62 scanning a plurality of documents. Specifically, a flow for executing processings for the image data will be explained with reference to FIG. 2. The image processing program 74a uses the operating system 74b to acquire scanning-execution command data that is transmitted from the mobile phone 10 and received by the network I/F 68. In response to the acquisition of the scanning-execution command data, the image processing program 74a starts the flow illustrated in FIG. 2. This flow begins with S100 at which the CPU 52 sends the scanner 62 a command for executing a scanning processing. Upon receipt of the command, the scanner 62 scans a plurality of documents placed on the document table to create an image file in a portable document format abbreviated as “PDF”. The created image file contains a plurality of image data to which sequential numbers are respectively assigned in order of the scanning. Specifically, a first ordinal number i is assigned to the image data, and each data is temporarily stored into the image-file storage area 54a in association with the ordinal number i. In the present embodiment, documents to be scanned are a set of documents created by two-side recording, and thus the command for executing the scanning processing in S100 is for commanding two-sided scanning. Also, the scanning-execution command data received by the network I/F 68 from the mobile phone 10 is data for commanding the two-sided scanning.

When front and back sides of all the documents are scanned, and the plurality of image data respectively corresponding to the sides of the scanned documents are stored into the image-file storage area 54a, the CPU 52 at S102 determines whether an image of a first page is blank or not. In other words, the CPU 52 determines whether no image is printed on the first page or not. Specifically, the CPU 52 obtains image data whose ordinal number i is “1” among the plurality of image data stored in the image-file storage area 54a and then determines whether the content of the obtained image data represents the blank-sheet data or not. In the following explanation, the wording “image data whose ordinal number i is “x” among the plurality of image data stored in the image-file storage area 54a” may be described as “image data having the ordinal number i (=x). Also, the wording “the content of the image data represents the blank-sheet data” may be referred to as “the image data contains the blank-sheet data” and “the image data is the blank-sheet data”.

When the image data having the ordinal number i (=1) does not contain the blank-sheet data (S102: NO), this flow goes to S104. At S104, the CPU 52 assigns a second ordinal number j to the image data representative of the first page, i.e., the image data having the ordinal number i (=1), and then the CPU 52 stores the number j and the image data having the ordinal number i (=1) in association with each other. It is noted that the ordinal number j is started from “1” and incremented by one at each assignment. That is, at S104, the ordinal number j (=1) and the image data having the ordinal number i (=1) are stored in association with each other. Upon completion of the processing at S104, this flow goes to S106.

On the other hand, when the image data having the ordinal number i (=1) contains the blank-sheet data (S102: YES), this flow goes to S108. The CPU 52 at S108 deletes the blank-sheet data from the image data having the ordinal number i (=1) and places or adds a first-page blank sheet mark to the image data. The CPU 52 then stores the ordinal number j (=1) and the image data having the ordinal number i (=1) in association with each other. As a result, data which represents that the first page is blank is stored. The first-page blank sheet mark is data which represents that the first page is blank or has no image or texts and which has a size less than blank-sheet data representative of one blank page. Upon completion of the processing at S108, this flow goes to S106.

The CPU 52 at S106 sets the ordinal number i to 2 and the ordinal number j to 2, and this flow goes to S110. The CPU 52 at S110 determines whether or not the ordinal number i has reached the number of the image data (i.e., the number of images) obtained by the scanner 62 (hereinafter referred to as “the number of the obtained image data n”). Specifically, the CPU 52 determines whether or not the ordinal number i is equal to or less than the number of the obtained image data n. When the ordinal number i is equal to or less than the number of the obtained image data n (S110: YES), this flow goes to S112. The CPU 52 at S112 determines whether each image data of both of the image data having the ordinal number i and the image data having the ordinal number i+1 is the blank-sheet data or not. When one or both of the image data having the ordinal number i and the image data having the ordinal number i+1 are not the blank-sheet data (S112: NO), this flow goes to S114.

The CPU 52 at S114 determines whether the image data having the ordinal number i is the blank-sheet data or not. When the image data having the ordinal number i is the blank-sheet data (S114: YES), this flow goes to S116. The CPU 52 at S116 deletes the blank-sheet data from the image data having the ordinal number i and places or adds a blank sheet mark to the image data. The CPU 52 then assigns the ordinal number j to the image data and stores the ordinal number j and the image data having the ordinal number i in association with each other. The CPU 52 then adds the blank sheet mark to the image data having the ordinal number j. As a result, data which represents that the jth page is blank is stored. The blank sheet mark is data which represents that the page is blank or has no image or texts and which has a data size less than blank-sheet data representative of one blank page. Upon completion of S116, this flow goes to S118.

On the other hand, when the image data having the ordinal number i is not the blank-sheet data (S114: NO), this flow goes to S120. The CPU 52 at S120 assigns the ordinal number j to the image data having the ordinal number i and stores the ordinal number j and the image data having the ordinal number i in association with each other. Upon completion of S120, this flow goes to S118.

The CPU 52 at S118 determines whether the image data having the ordinal number i+1 is the blank-sheet data or not. When the image data having the ordinal number i+1 is the blank-sheet data (S118: YES), this flow goes to S122. The CPU 52 at S122 deletes the blank-sheet data from the image data having the ordinal number i+1 and adds the blank sheet mark to the image data. The CPU 52 then assigns the ordinal number j+1 to the image data having the ordinal number i+1. As a result, the data which represents that the j+1th page is blank is stored. Upon completion of S122, this flow goes to S123.

On the other hand, when the image data having the ordinal number i+1 is not the blank-sheet data (S118: NO), this flow goes to S126. The CPU 52 at S126 assigns the ordinal number j+1 to the image data having the ordinal number i+1 and stores the ordinal number j+1 and the image data having the ordinal number i+1 in association with each other. Upon completion of S126, this flow goes to S123. The CPU 52 at S123 adds two to the ordinal number j, and this flow goes to S124

On the other hand, when the CPU 52 at S112 determines that each image data of both of the image data having the ordinal number i and the image data having the ordinal number i+1 is the blank-sheet data (S112: YES), this flow goes to S124. That is, when each image data of both of the image data having the ordinal number i and the image data having the ordinal number i+1 is the blank-sheet data, the ordinal numbers j and j+1 are not assigned to the image data having the ordinal numbers and i+1, and the blank sheet mark is not stored.

The CPU 52 at S124 adds two to the ordinal number i, and this flow returns to S110.

On the other hand, when the CPU 52 at S110 determines that the ordinal number i is not equal to or less than the number of the obtained image data n (S110: NO), this flow goes to S130. The CPU 52 at S130 determines whether image data representative of the last page, i.e., image data having the ordinal number i (=n) is the blank-sheet data or not. When the image data having the ordinal number i (=n) is the blank-sheet data (S130: YES), this flow ends. That is, when the last page is blank, the ordinal number j is not assigned, and the blank sheet mark is not stored.

On the other hand, when the image data having the ordinal number i (=n) is not the blank-sheet data (S130: NO), this flow goes to S132. The CPU 52 at S132 assigns the ordinal number j to the image data having the ordinal number i and stores the ordinal number j and the image data having the ordinal number i in association with each other, and this flow ends. It is noted that, before the end of this flow, the CPU 52 deletes all image data not associated with the ordinal number j.

In this way, when the processings in FIG. 2 are executed according to the image processing program 74a, the image file created in S100 is edited, resulting in creation of the PDF image file containing the image data to which the next or new ordinal numbers j are respectively assigned. After the creation of the image file for which the next or new ordinal numbers j are assigned, the image processing program 74a outputs, as reply data for replying to the scanning-execution command data, command data for commanding the MFP 50 to transmit the created image file to the mobile phone 10 via the network I/F 68, whereby the created image file is transmitted to the mobile phone 10 as the reply data for replying to the scanning-execution command data.

<Operations of Mobile Phone>

There will be next explained operations of the mobile phone 10 in the first embodiment. The image-file storage area 14a of the mobile phone 10 stores the image file containing the plurality of image data processed by the execution of the above-described image processing program 74a. Specifically, the image-file storage area 14a stores the image file that is received from the MFP 50 by the wireless transmitting and receiving portion 16 as the reply data for replying to the scanning-execution command data after the viewer application 32a causes the mobile phone 10 to transmit the scanning-execution command data to the MFP 50. In the mobile phone 10, the viewer application 32a causes the panel 22 to display thereon an image or images based on the image data stored in the image-file storage area 14a. It is noted that this mobile phone 10 has two display manners for displaying the image(s) on the panel 22: a display manner for displaying two images respectively corresponding to successive two pages on the panel 22 in a two-page spread layout; and a display manner for displaying one image corresponding to one page on the panel 22 in a single page layout. A user can select one of these two display manners with the button input portion 20.

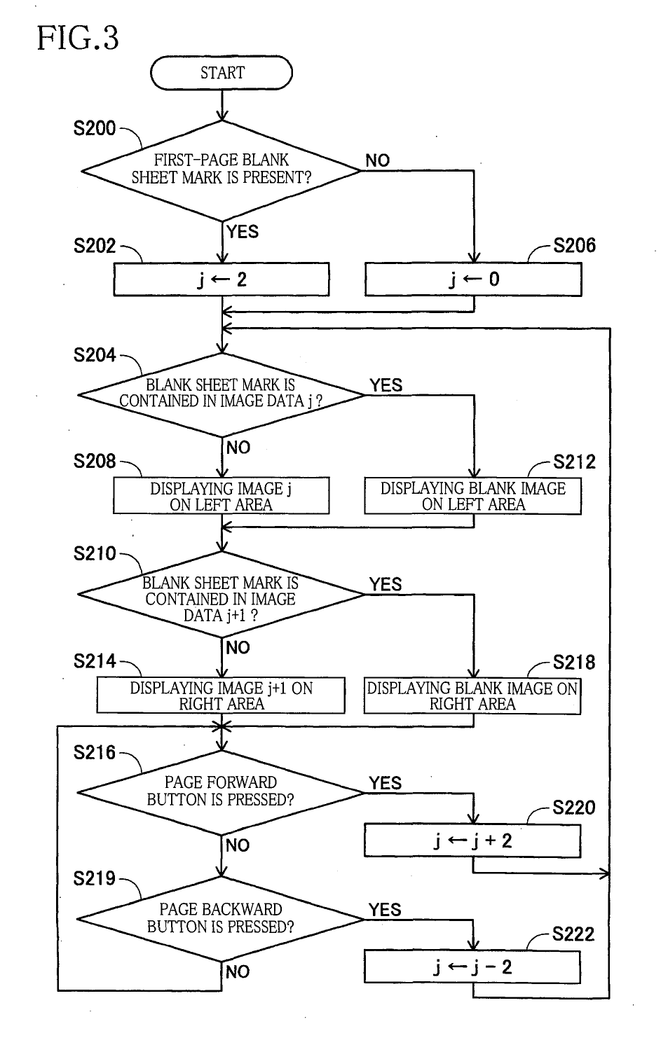

There will be next explained, with reference to a flow chart in FIG. 3, processings for displaying images on the panel 22 when the two-page spread layout is selected. This flow begins with S200 at which the CPU 12 determines whether the image of the first page is blank or not. Specifically, the CPU 52 obtains image data whose ordinal number j is 1 among the plurality of image data stored in the image-file storage area 14a and then determines whether the content of the obtained image data contains data representative of the first page or not. In the following explanation, the wording “image data whose ordinal number j is “x” among the plurality of image data stored in the image-file storage area 14a” may be described as “image data having the ordinal number j (=x)”.

When the first-page blank sheet mark is contained in or attached to the image data having the ordinal number j (=1) (S200: YES), this flow goes to S202. The CPU 12 at S202 sets the ordinal number j to “2”, and this flow goes to S204.

On the other hand, when the first-page blank sheet mark is not contained in the image data having the ordinal number j (=1) (S200: NO), this flow goes to S206. The CPU 12 at S206 sets the ordinal number j to “0”, and this flow goes to S204. It is noted that image data having the ordinal number j (=0) does not exist in reality but is assumed to exist for the sake of convenience. Also, it is assumed that the blank sheet mark is contained in the image data having the ordinal number j (=0). The CPU 12 at S204 determines whether the blank sheet mark is contained in the image data having the ordinal number j or not. When the blank sheet mark is not contained in the image data having the ordinal number j (S204: NO), this flow goes to S208. The CPU 12 at S208 displays an image based on the image data having the ordinal number j on a left portion of the panel 22. Upon completion of S208, this flow goes to S210.

On the other hand, when the blank sheet mark is contained in the image data having the ordinal number j (S204: YES), this flow goes to S212. The CPU 12 at S212 displays a blank-sheet image or a blank image on the left portion of the panel 22. Upon completion of S212, this flow goes to S210. The CPU 12 at S210 determines whether or not the blank sheet mark is contained in or attached to the image data having the ordinal number j+1. When the blank sheet mark is not contained in the image data having the ordinal number j+1 (S210: NO), this flow goes to S214. The CPU 12 at S214 displays the image based on the image data having the ordinal number j+1 on a right portion of the panel 22. Upon completion of S214, this flow goes to S216.

On the other hand, when the blank sheet mark is contained in the image data having the ordinal number j+1 (S210: YES), this flow goes to S218. The CPU 12 at S218 displays the blank-sheet image on the right portion of the panel 22. Upon completion of S218, this flow goes to S216. The CPU 12 at S216 determines whether or not the user has operated the button input portion 20 to turn a page forward. When the operation for turning a page forward is performed (S216: NO), this flow goes to S219. The CPU 12 at S219 determines whether or not the user has operated the button input portion 20 to turn a page backward. When the operation for turning a page backward is not performed (S219: NO), this flow returns to S216.

On the other hand, when the operation for turning a page forward is performed (S216: YES), this flow goes to S220. The CPU 12 at S220 adds two to the ordinal number j, and this flow returns to S204.

On the other hand, when the operation for turning a page backward is performed (S219: YES), this flow goes to S222. The CPU 12 at S222 subtracts two from the ordinal number j, and this flow returns to S204.

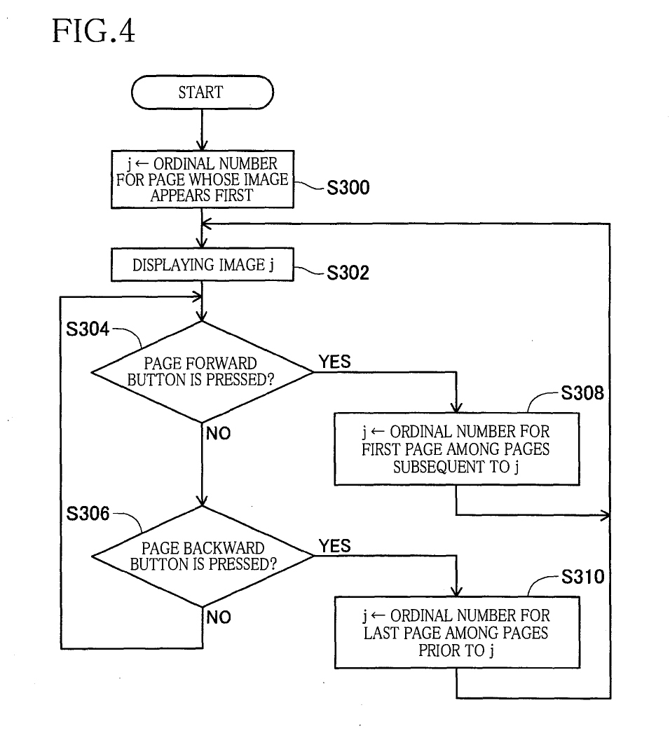

There will be next explained, with reference to a flow chart in FIG. 4, processings for displaying images on the panel 22 when the single page layout is selected. The CPU 12 at S300 extracts the smallest ordinal number j not containing the first-page blank sheet mark or the blank sheet mark from among the image data. That is, the CPU 12 determines, as the ordinal number j, the ordinal number j assigned to the page whose image appears first on the panel 22. Upon completion of the processing at S300, this flow goes to S302. The CPU 12 at S302 controls the panel 22 to display the image based on the image data having the ordinal number j extracted at S300, and this flow goes to S304.

The CPU 12 at S304 determines whether or not the user has operated the button input portion 20 to turn a page forward. When the operation for turning a page forward is performed (S304: NO), this flow goes to S306. The CPU 12 at S306 determines whether or not the user has operated the button input portion 20 to turn a page backward. When the operation for turning a page backward is not performed (S306: NO), this flow returns to S304.

On the other hand, when the operation for turning a page forward is performed (S304: YES), this flow goes to S308. The CPU 12 at S308 extracts the smallest ordinal number j with no blank sheet mark from among image data each having the ordinal number j larger than the currently set ordinal number j. The CPU 12 then sets the extracted number to the ordinal number j. That is, the CPU 12 sets, as the ordinal number j, the ordinal number j assigned to the image data representative of the image just after the image being displayed, and this flow returns to S302.

On the other hand, when the CPU at S306 determines that the operation for turning a page backward is performed (S306: YES), this flow goes to S310. The CPU 12 at S310 extracts the largest ordinal number j with no blank sheet mark from among image data each having the ordinal number j smaller than the currently set ordinal number j. The CPU 12 then sets the extracted number to the ordinal number j. That is, the CPU 12 sets, as the ordinal number j, the ordinal number j assigned to the image data representative of the image just before the image being displayed, and this flow returns to S302.

<Effects>

In the MFP 50 in the first embodiment, when each image data of both of the image data having the ordinal number i and the image data having the ordinal number i+1 is the blank-sheet data (S112: YES), the blank sheet mark that represents the image is blank is not stored. That is, when the image data having the ordinal number i and the image data having the ordinal number i+1 are two successive image data to be displayed in the two-page spread layout and when each of both of the two image data is the blank-sheet data, the two successive blank-sheet data are deleted without stored in the image-file storage area 54a. Also, the ordinal number i upon deletion of the image data is limited to an even number (S106, S124). That is, the CPU 52 deletes two image data representative of the respective two images to be displayed at a time on the panel 22 of the mobile phone 10 in the two-page spread layout.

On the other hand, when at least one of the image data having the ordinal number i and the image data having the ordinal number i+1 is not the blank-sheet data (S112: NO) and when the ordinal number i or the image data having the ordinal number i+1 is the blank-sheet data (S114: YES, S118: YES), information that the image data is the blank-sheet data is stored (S116, S122). That is, when the image data having the ordinal number i and the image data having the ordinal number i+1 are two successive image data to be displayed in the two-page spread layout and when one of the two image data is the blank-sheet data while the other of the two image data is not the blank-sheet data, the blank sheet mark that represents the image is blank is added to the one image data to store information that the one image data is the blank-sheet data.

Also, in the mobile phone 10 in the first embodiment, when the image is displayed on the panel 22 in the two-page spread layout on the basis of the image data containing the blank sheet mark (S204: YES, S210: YES), the blank image is displayed on the panel 22 (S212, S218).

On the other hand, in the case of the single page layout, the image is displayed on the panel 22 (S302) only when the image is present. That is, all the blank images are not displayed on the panel 22.

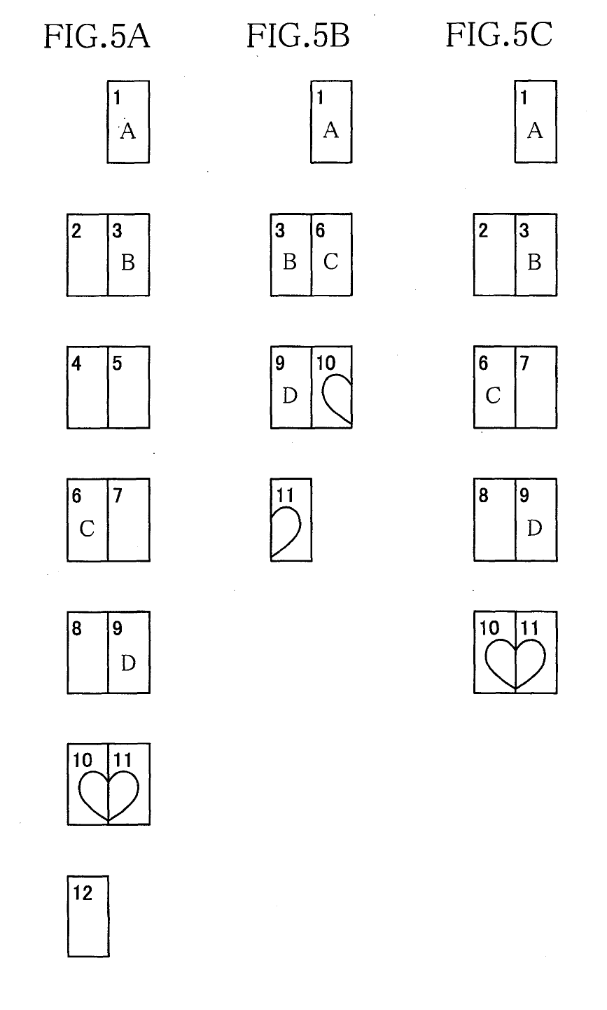

Here, there will be explained effects of the MFP 50 and the mobile phone 10 with specific examples. For example, consider a case where two-sided scanning is performed on six documents on which the two-side recording has been performed, i.e., a case where twelve images are scanned. It is assumed that second, fourth, fifth, seventh, eighth, and twelfth pages of the twelve pages are blank. FIG. 5A illustrates display aspects in a case where images based on image data of these twelve pages are displayed on the panel 22 in the two-page spread layout. The display aspect in each line in FIG. 5A corresponds to a screen displayed on the panel 22 at a time.

As seen in FIG. 5A, a heart-shaped picture is displayed on a screen corresponding to the sixth display aspect from the top. This is because an image of the tenth page is a picture of a left half portion of the heart shape, and an image of the eleventh page is a picture of a right half portion of the heart shape. That is, one image is constituted by the images of these two pages. It is noted that an image of the first page is displayed on the right portion of the panel 22, and no image is displayed on a left side of the image of the first page. This is because an actual bound printed material is in most cases designed such that the first page of the bound printed material is located on a right portion of the bound printed material, and there is no page on a left portion of the bound printed material, i.e., on a left side of the first page, with the bound printed material being opened.

Since there are many blank-sheet images on the display aspects in FIG. 5A, there is a possibility that the user cannot comfortably view the images displayed on the mobile phone 10. Then, consider a case where all the blank-sheet images are not displayed on the panel 22. FIG. 5B illustrates display aspects in this case. As seen in this figure, no blank-sheet images are displayed, but the heart-shaped picture is displayed in a separated state.

Now consider a case where images of the image file processed by the MFP 50 are displayed on the panel 22 of the mobile phone 10. FIG. 5C illustrates display aspects in this case. As described above, the MFP 50 deletes image data of two blank-sheet images which should be displayed on the panel 22 at a time. Thus, the mobile phone 10 does not display a screen corresponding to the third display aspect from the top in FIG. 5A. As a result, it is possible to inhibit only the blank-sheet images from appearing on the panel 22.

Also, the MFP 50 writes the blank sheet mark on the image data representative of the blank-sheet image not successive to another blank-sheet image. Furthermore, in the case of the two-page spread layout, the mobile phone 10 displays the image based on the image data containing the blank sheet mark. That is, as illustrated in FIG. 5C, the second page is displayed. As a result, it is possible to correctly display the heart-shaped picture constituted by the images of the tenth page and the eleventh page. Also, in the case of the single page layout, the mobile phone 10 does not display the image based on the image data containing the blank sheet mark. This makes it possible to inhibit all the blank-sheet images from appearing on the panel 22 in the single page layout.

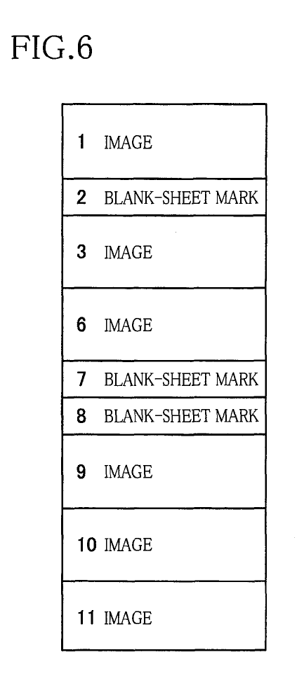

Here, consider an amount of information or an information amount of the image file stored in the image-file storage area 14a of the mobile phone 10 and the image-file storage area 54a of the MFP 50. FIG. 6 is a conceptual view illustrating the information amount of the image file containing the images illustrated in FIG. 5C. As seen from this figure, image data of the fourth and fifth pages are deleted. Also, the blank-sheet data is deleted from image data representative of the second, seventh, and eighth pages, and the blank sheet mark is added thereto. A data amount of the blank sheet mark as one example of blank-sheet command data is less than that of each of the blank-sheet data and the image data. Thus, the information amount of the image data representative of each of the second, seventh, and eighth pages is less than that of each of the other image data, resulting in reduced information amount of the image file stored in the image-file storage areas 14a, 54a.

Also, when the image data representative of the first page is the blank-sheet data (S102: YES), the first-page blank sheet mark is stored without the blank sheet mark stored (S108). Also, when the first-page blank sheet mark is present (S200: YES), the first page is not displayed in the case of the two-page spread layout (S202). Thus, when the first page is blank, it is possible to inhibit the image of the first page from being displayed regardless of whether the page next to the first page is blank or not.

Also, when the last page is the blank image data to be output alone on the panel 22 (S130: YES), the blank sheet mark is not stored. As a result, when the last page is the blank image data to be output alone on the panel 22, it is possible to inhibit the image of the last page from being displayed regardless of whether the page just before the last page is blank or not.

### Second Embodiment

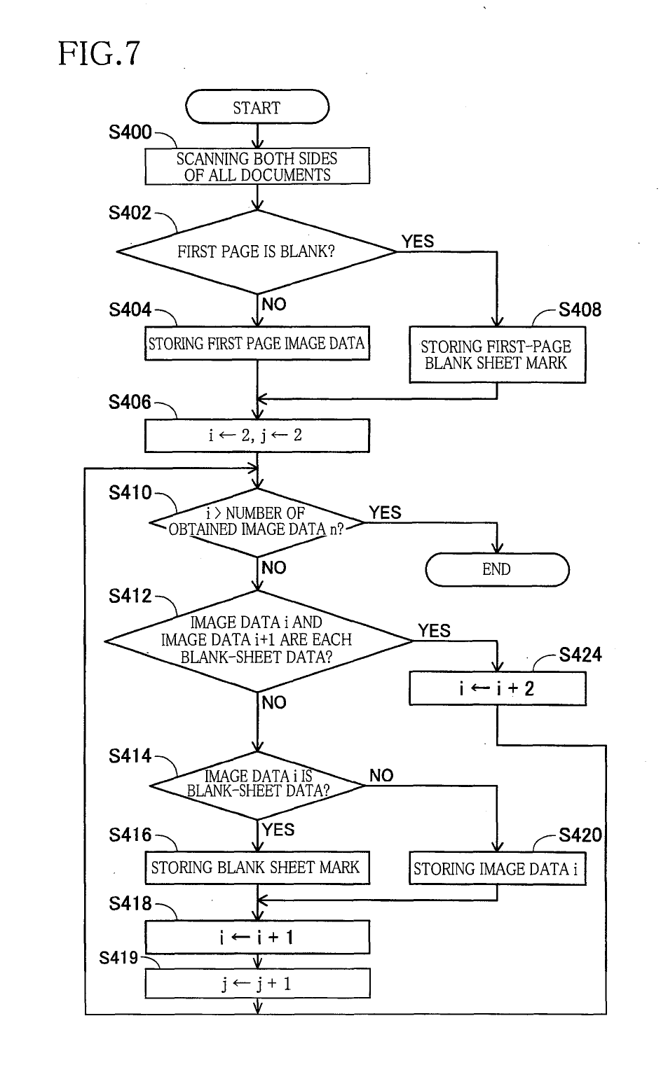

There will be next explained operations of the MFP 50 in a second embodiment with reference to a flow chart in FIG. 7. It is noted that the structure of the MFP 50 in this second embodiment is similar to that in the first embodiment, and an explanation of which is dispensed with.

The processings in the flow chart in FIG. 7 are the same as those in the flow chart in FIG. 2 except for processings at S410 and subsequent steps, and accordingly an explanation of the other processings is omitted. The CPU 52 at S410 determines whether the ordinal number i has reached the number of image data obtained by the scanner 62 or not. Specifically, the CPU 52 determines whether or not the ordinal number i is greater than the number of the obtained image data n. When the ordinal number i is not greater than the number of the obtained image data n (S410: NO), this flow goes to S412. The CPU 52 at S412 determines whether each image data of both of the image data having the ordinal number i and the image data having the ordinal number i+1 is the blank-sheet data or not. When one or both of the image data having the ordinal number i and the image data having the ordinal number i+1 are not the blank-sheet data (S412: NO), this flow goes to S414.

The CPU 52 at S414 determines whether the image data having the ordinal number i is the blank-sheet data or not. When the image data having the ordinal number i is the blank-sheet data (S414: YES), this flow goes to S416. The CPU 52 at S416 deletes the blank-sheet data from the image data having the ordinal number i and adds the blank sheet mark to the image data. The CPU 52 then assigns the ordinal number j to the image data. That is, the CPU 52 stores the ordinal number j and the image data having the ordinal number i in association with each other. The CPU 52 then adds the blank sheet mark to the image data having the ordinal number j. As a result, the data which represents that the jth page is blank is stored. Upon completion of S416, this flow goes to S418.

On the other hand, when the image data having the ordinal number i is not the blank-sheet data (S414: NO), this flow goes to S420. The CPU 52 at S420 assigns the ordinal number j to the image data having the ordinal number i and stores the ordinal number j and the image data having the ordinal number i in association with each other. Upon completion of S420, this flow goes to S418. The CPU 52 at S418 adds one to the ordinal number i, and this flow goes to S419. The CPU 52 at S419 add one to the ordinal number j, and this flow returns to S410.

On the other hand, when the CPU 52 at S412 determines that each image data of both of the image data having the ordinal number i and the image data having the ordinal number i+1 is the blank-sheet data (S412: YES), this flow goes to S424. The CPU 52 at S424 adds two to the ordinal number i, and this flow returns to S410. That is, when each image data of both of the image data having the ordinal number i and the image data having the ordinal number i+1 is the blank-sheet data, the ordinal number j is not assigned, and the blank sheet mark is not stored.

On the other hand, when the CPU 52 at S410 determines that the ordinal number i is greater than the number of the obtained image data n (S410: YES), this flow ends. It is noted that, before the end of this flow, the CPU 52 deletes all image data not associated with the ordinal number j.

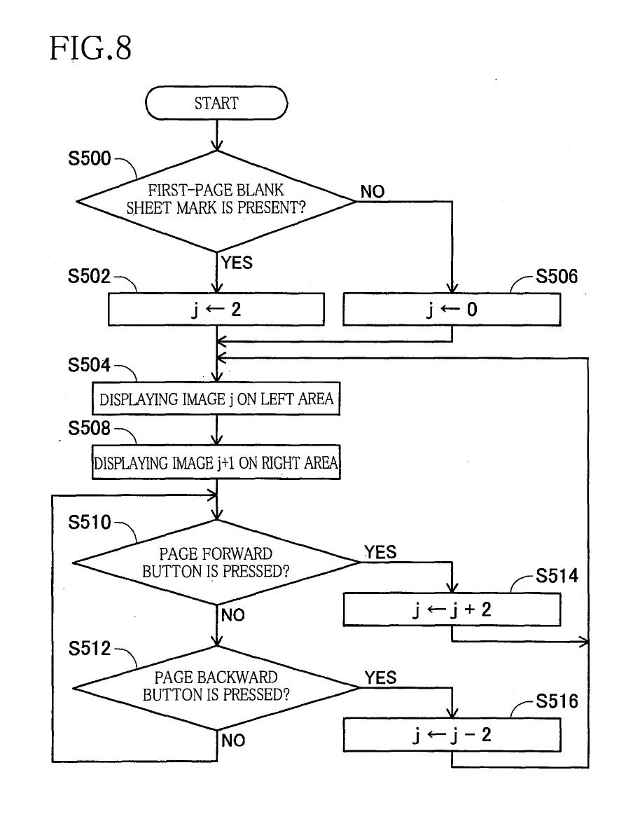

There will be next explained operations of the mobile phone 10 in the second embodiment with reference to a flow chart in FIG. 8. In the flow chart illustrated in FIG. 8, the images are displayed on the panel 22 in the two-page spread layout. It is noted that the structure of the mobile phone 10 in this second embodiment is similar to that in the first embodiment, and an explanation of which is dispensed with.

The processings in the flow chart in FIG. 8 are the same as those in the flow chart in FIG. 3 except for processings at S504 and S508, and accordingly the processings at S504 and S508 will be explained. After the processing at S502 or S506, the CPU 12 at S504 displays the image based on the image data having the ordinal number j on the left portion of the panel 22. It is noted that, when the blank sheet mark is contained in the image data having the ordinal number j, the CPU 12 displays the blank-sheet image on the left portion of the panel 22. Upon completion of S504, this flow goes to S508. The CPU 12 at S508 displays the image based on the image data having the ordinal number j+1 on the right portion of the panel 22. It is noted that, when the blank sheet mark is contained in the image data having the ordinal number j+1, the CPU 12 displays the blank-sheet image on the right portion of the panel 22. Upon completion of S508, this flow goes to S510.

It is noted that the specific processing for displaying the images in the single page layout by the mobile phone 10 in the second embodiment is the same as the processing for displaying the images by the mobile phone 10 in the first embodiment. That is, the specific processing for displaying the images in the single page layout by the mobile phone 10 in the second embodiment is the same as the above-described processings at S300-S310, and an explanation of which is dispensed with.

<Effects>

In the MFP 50 in the second embodiment, when each image data of both of the image data having the ordinal number i and the image data having the ordinal number i+1 is the blank-sheet data (S412: YES), the blank sheet mark is not stored. Also, the ordinal number i upon deletion of the image data is not limited as long as the number is equal to or greater than two (S406, S418, S424). That is, when each of successive two pages respectively based on two image data of the plurality of image data is blank, images of the successive two pages are not displayed on the panel 22. Specifically, in the mobile phone 10 in the second embodiment, images of the seventh and eighth pages illustrated in FIG. 5C are not displayed, and images of the sixth and ninth pages are displayed at a time. Thus, it is possible to reduce the number of blank-sheet images displayed on the panel 22. Also, it is possible to reduce the information amount of the image file stored in the image-file storage areas 14a, 54a.

### Third Embodiment

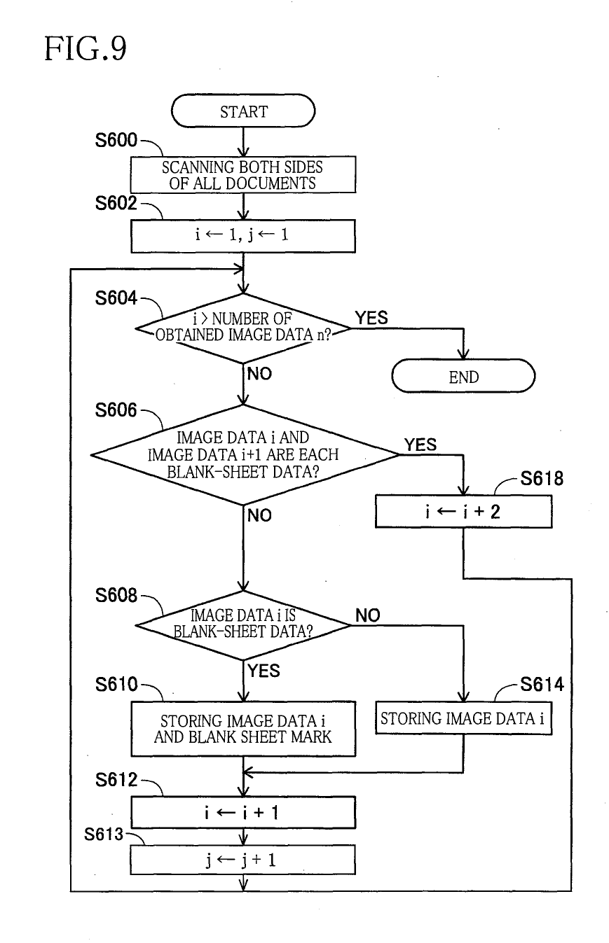

There will be next explained operations of the MFP 50 in a third embodiment with reference to a flow chart in FIG. 9. It is noted that the structure of the MFP 50 in this third embodiment is similar to that in the first embodiment, and an explanation of which is dispensed with.

The processings in the flow chart in FIG. 9 are the same as those in the flow chart in FIG. 7 except for processings at S602, S610, and S614, and accordingly the processings at S602, S610, and S614 will be explained. After the processing at S600, the CPU 52 at S602 sets one to the ordinal number i and one to the ordinal number j, and this flow goes to S604.

Also, when the positive decision (YES) is made at S608, the CPU 52 at S610 assigns the ordinal number j to the image data having the ordinal number i and stores the ordinal number j and the image data having the ordinal number i in association with each other. The CPU 52 also adds the blank sheet mark to the image data having the ordinal number j. As a result, the data which represents that the jth page is blank is stored, and the blank-sheet data is also stored. Upon completion of S610, this flow goes to S612.

On the other hand, when the negative decision (NO) is made at S608, the CPU 52 at S614 assigns the ordinal number j to the image data having the ordinal number i and stores the ordinal number j and the image data having the ordinal number i in association with each other. Upon completion of S614, this flow goes to S612 and S613. It is noted that, before the end of this flow, the CPU 52 deletes all image data not associated with the ordinal number j.

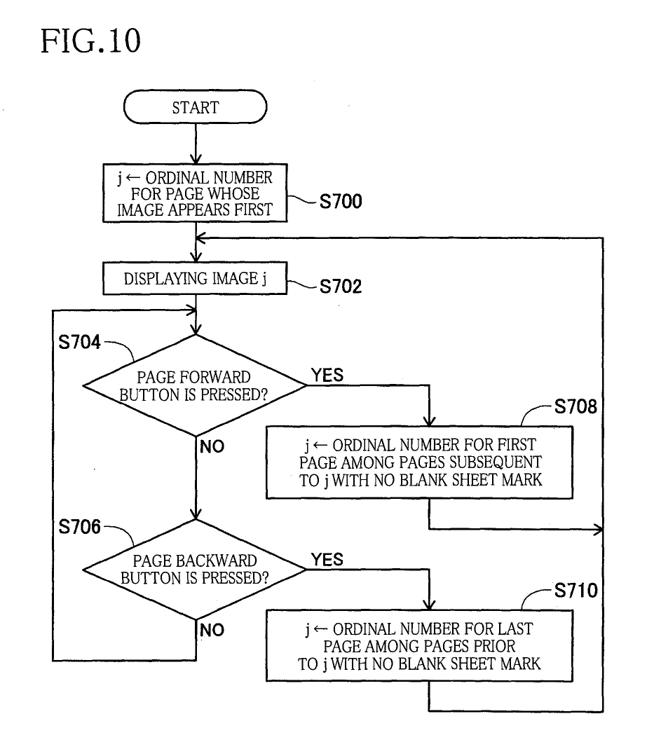

There will be next explained operations of the mobile phone 10 in the third embodiment with reference to a flow chart in FIG. 10. In the flow chart illustrated in FIG. 10, the images are displayed on the panel 22 in the single page layout. It is noted that the structure of the mobile phone 10 in this third embodiment is similar to that in the first embodiment, and an explanation of which is dispensed with.

The processings in the flow chart in FIG. 10 are the same as those in the flow chart in FIG. 4 except for processings at S700, S708, and S710, and accordingly the processings at S700, S708, and S710 will be explained. The CPU 12 at S700 determines, as the ordinal number 5, the ordinal number j assigned to the image data based on the page whose image appears first on the panel 22 among the image data not containing the blank sheet mark, and this flow goes to S702.

Also, when the positive decision (YES) is made at S704, the CPU 12 at S708 extracts the smallest ordinal number j with no blank sheet mark from among image data each having the ordinal number j larger than the currently set ordinal number j. The CPU 12 then sets the extracted number to the ordinal number j, and this flow returns to S702.

When the positive decision (YES) is made at S706, the CPU 12 at S710 extracts the largest ordinal number j with no blank sheet mark from among image data each having the ordinal number j smaller than the currently set ordinal number j. The CPU 12 then sets the extracted number to the ordinal number j, and this flow returns to S702.

It is noted that the specific processing for displaying the images in the two-page spread layout by the mobile phone 10 in the third embodiment is the same as the processing for displaying the images by the mobile phone 10 in the second embodiment. That is, the specific processing for displaying the images in the two-page spread layout by the mobile phone 10 in the third embodiment is the same as the above-described processings at S500-S516, and an explanation of which is dispensed with.

<Effects>

In the MFP 50 in the third embodiment, the blank-sheet data is stored together with the blank sheet mark in the case of the blank-sheet image (S610). Thus, even a display device in which the viewer application 32a is not embedded can appropriately display the images in the two-page spread layout, for example. This will be explained in detail. In the display device in which the viewer application 32a is not embedded, the blank sheet mark cannot be read. Thus, when the blank-sheet data is absent, the display device determines that there is no image data. That is, the blank-sheet image not successive to another blank-sheet image is skipped on the display aspect in the two-page spread layout. In this case, there is a possibility that a picture that should be displayed on a pair of right and left pages are displayed on the panel 22 in the separated state as illustrated in FIG. 5B in images subsequent to the skipped blank-sheet image. In the MFP 50 in the third embodiment, however, since the blank-sheet data is stored, the blank-sheet image not successive to another blank-sheet image is displayed on the panel 22 on the display aspect in the two-page spread layout. Thus, even the display device in which the viewer application 32a is not embedded can appropriately display the images in the two-page spread layout.

<Modifications>

In the above-described embodiments, when each of the image data of the successive two pages is the blank-sheet data, the image data is deleted without storing the output command data, i.e., the blank-sheet data, but the present invention is not limited to this configuration. When each of the image data of the successive two pages is the blank-sheet data, a non-output command data may be stored for commanding the output device not to output the blank-sheet image. Also in this modification, it is possible to inhibit the output device from outputting the image data of the successive two pages.

Also, while the image file to be processed by the viewer application 32a is received by the MFP 50 in the above-described embodiments, the method of obtaining the image file is not limited to this method, and various methods may be adopted. For example, the image file may be obtained from a non-transitory memory mounted on a memory slot, not shown. That is, the MFP 50 may be configured such that, after executing the processings in the flow chart in FIG. 2 to create a new image file, the image processing program 74a stores the created image file into the non-transitory memory mounted on the MFP 50. In this configuration, when the non-transitory memory in which the image file is stored by the image processing program 74a is mounted on the memory slot of the mobile phone 10, the viewer application 32a is enabled to obtain the image file.

Also, the display device for displaying the image file is not limited to the mobile phone 10 and may be devices such as a note PC and a tablet device. Also, the panel 56 of the MFP 50 may be used as the display device.

Also, the output manner of the images contained in the image file is not limited to the display on the display device and may be printing on, e.g., a paper medium by a printing device.

In the above-described embodiments, the CPU 52 of the MFP 50 executes various processings such as the processings as illustrated in FIG. 2, 7, or 9 according to the image processing program 74a. Nevertheless, the present invention is not limited to this configuration. For example, the mobile phone 10 may be installed with an image processing program 32c, not shown, equivalent to the image processing program 74a, for executing various processings such as the processings as illustrated in FIG. 2, 7, or 9 according to this image processing program 32c. This will be explained specifically. It is assumed that the MFP 50 is configured to transmit the image file in PDF format created by the scanner 62, to the mobile phone 10 without executing the processings according to the image processing program 74a. The image processing program 32c of the mobile phone 10 starts the processing illustrated in FIG. 2, 7, or 9 after outputting command data for transmitting the scanning-execution command data to the MFP 50 via the wireless transmitting and receiving portion 16. At S100, the image processing program 32c uses the operating system 32b to obtain the image file received from the MFP 50 by the wireless transmitting and receiving portion 16. Processings at the other steps are similar to those in the image processing program 74a. After creating the image file for which the new ordinal numbers j are assigned, the image processing program 32c may transmit, as reply data for replying to the image file received from the MFP 50, the created image file via the wireless transmitting and receiving portion 16 to the printer by outputting command data for commanding a printer, not shown, to print two images on each sheet.

It is noted that the format of the image file is not limited to the PDF format and may be various formats such as a multipage TIFF format and a WORD format.

Also, at S104, S108, S116, S122, S132, S404, S408, S416, and S610, the CPU 52 may edit original image data by, e.g., size reduction, size enlargement, and color subtraction, and store the edited image data.

Also, the CPU 52 at S100 may use the created image file to create individual image files. Specifically, at S104, S108, S116, S122, S132, S404, S408, S416, and S610, the CPU 52 may store one of image data into a storage area of a corresponding one of the individual image files. It is noted that the format of each individual image file may differ from that of the image file created at S100.

In the mobile phone 10 in the above-described embodiments, the CPU 12 executes the various processings according to the viewer application 32a. Nevertheless, the present invention is not limited to this configuration. For example, the CPU 12 according to the viewer application 32a may output a command for commanding the operating system 32b and other systems and hardware to execute the various processings.

Also, in the MFP 50 in the above-described embodiments, the CPU 52 executes the various processings according to the image processing program 74a. Nevertheless, the present invention is not limited to this configuration. For example, the CPU 52 according to the image processing program 74a may output a command for commanding the operating system 74b and other systems and hardware to execute the various processings.

The technological elements described in the present specification or the drawings exhibit technological utility individually or in various combinations and are not limited to the combinations disclosed in the claims at the time of filing. Furthermore, the technology illustrated in the present specification or the drawings may simultaneously achieve a plurality of objects, and have technological utility by achieving one of these objects.

The blank-sheet data is one example of output command data and blank-sheet command data. Each of the panel 22 and the mobile phone 10 is one example of an output device. The CPU 12 is one example of a computer of the output device. The viewer application 32a is one example of an image output program. The image-file storage area 54a is one example of a storage device. The MFP 50 is one example of an image-data obtaining device. The CPU 52 is one example of a computer of the image-data obtaining device. The CPU 52 that executes the processings at, e.g., S100 is one example of an image-data obtaining unit and an image-file obtaining unit. The CPU 52 that executes the processings at, e.g., S104, S120, S126, and S132 is one example of a first processing unit. The CPU 52 that executes the processings at, e.g., S116 and S122 is one example of a second processing unit. The CPU 52 that executes the processings at, e.g., S112 is one example of a third processing unit. The CPU 12 that executes the processings at, e.g., S212 and S218 is one example of a transmission control unit. The CPU 12 that executes the processings at, e.g., S208 and S214 is one example of a first transmission control unit. The CPU 12 that executes the processings at, e.g., S212 and S218 is one example of a second transmission control unit. The CPU 52 that executes the processings at, e.g., S112 is one example of a third transmission control unit.

It is noted that each program may be constituted by a single program module or a plurality of program modules. Each of the above-described examples may be in other forms as long as the similar function is exhibited. For example, each example may be: a computer, e.g., the CPU 12, for executing processings based on an image output program, e.g., the viewer application 32a; a computer, e.g., the CPU 52, for executing processings based on an image output program, e.g., the image processing program 74a; a computer for executing processings based on a program different from the image output program and the image processing program, e.g., an operating system and other applications and programs; hardware, e.g., the panel 22, operable according to a command supplied from a computer; and a configuration in which a computer and hardware cooperate. It should be understood that each example may be a computer configured to execute processings by executing processings according to a plurality of programs and may be hardware operable by a command supplied from a computer configured to execute processings by executing processings according to a plurality of programs.

What is claimed is:

1. A non-transitory computer-readable medium storing an image processing program executable by a computer of an image-data processing device configured to process image data to be used for an output device configured to output an image, the image processing program being designed to cause the computer to function as:
an image-data obtaining unit configured to obtain a plurality of image data respectively corresponding to a plurality of successive pages, the plurality of image data comprising one image data and two image data respectively prior to and subsequent to the one image data successively;
a first processing unit configured, when the one image data obtained by the image-data obtaining unit is not blank-sheet data, to establish a state in which a storage device stores one of the one image data and another image data, wherein said another image data is image data based on which the output device outputs an image equivalent or similar to an image output by the output device based on the one image data;
a second processing unit configured, when the one image data of the plurality of image data obtained by the image-data obtaining unit is the blank-sheet data and when each of the two image data respectively prior to and subsequent to the one image data successively is not the blank-sheet data, to establish a state in which the storage device stores output command data for commanding the output device to output a blank-sheet image as an image corresponding to the one image data; and
a third processing unit configured, when the one image data of the plurality of image data obtained by the image-data obtaining unit is the blank-sheet data and when one successive image data that is one of the two image data respectively prior to and subsequent to the one image data successively is the blank-sheet data, to establish a state in which the storage device does not store the output command data for commanding the output device to output the blank-sheet image as the image corresponding to the one image data.

2. The non-transitory computer-readable medium according to claim 1, wherein the image processing program is designed to cause the computer to further function as a transmission control unit configured to transmit the image data stored in the storage device and the output command data obtained by the image-data obtaining unit and stored in the storage device, to the output device via an interface of the image-data processing device.

3. The non-transitory computer-readable medium according to claim 1, wherein the image processing program is designed to cause the computer to further function as an image-file storing unit configured to store an image file into the storage device, the image file comprising the image data stored in the storage device and the output command data stored in the storage device.

4. The non-transitory computer-readable medium according to claim 1, wherein the second processing unit is configured to establish a state in which blank-sheet command data whose data amount is less than that of the blank-sheet data is stored in the storage device as the output command data, without establishing a state in which the blank-sheet data is stored in the storage device.

5. The non-transitory computer-readable medium according to claim 1, wherein the second processing unit is configured to establish a state in which the blank-sheet data obtained by the image-data obtaining unit is stored in the storage device as the output command data.

6. The non-transitory computer-readable medium according to claim 1, wherein the second processing unit is configured, when the one image data of the plurality of image data obtained by the image-data obtaining unit is the blank-sheet data and when the one successive image data successive to the one image data is not the blank-sheet data but image data that is to be output together with the one image data at a time by the output device, to establish the state in which the storage device stores the output command data for commanding the output device to output the blank-sheet image as the image corresponding to the one image data.

7. The non-transitory computer-readable medium according to claim 1, wherein the third processing unit is configured to establish the state in which the storage device does not store the one image data and the output command data for commanding the output device to output the blank-sheet image as the image corresponding to the one image data.

8. The non-transitory computer-readable medium according to claim 1, wherein the third processing unit is configured, when the one image data of the plurality of image data obtained by the image-data obtaining unit is the blank-sheet data, when the one successive image data successive to the one image data is the blank-sheet data, and when the one image data and the one successive image data are image data to be output together at a time by the output device, to establish the state in which the storage device does not store the output command data for commanding the output device to output the blank-sheet image as the image corresponding to the one image data.

9. The non-transitory computer-readable medium according to claim 1, wherein the third processing unit is configured not to establish the state for image data obtained first among the plurality of image data obtained by the image-data obtaining unit.

10. The non-transitory computer-readable medium according to claim 1, wherein the second processing unit is configured, when image data obtained last among the plurality of image data obtained by the image-data obtaining unit is the blank-sheet data and when the image data obtained last and image data successively prior thereto are image data not to be output together at a time by the output device, to establish a state in which the storage device does not store output command data for commanding the output device to output a blank-sheet image as an image corresponding to the image data obtained last.

11. A non-transitory computer-readable medium storing an image processing program executable by a computer of an image-data processing device configured to process image data to be used for an output device configured to output an image, the image processing program being designed to cause the computer to function as:
an image-data obtaining unit configured to obtain a plurality of image data respectively corresponding to a plurality of successive pages, the plurality of image data comprising one image data and two image data respectively prior to and subsequent to the one image data successively;
a first processing unit configured, when the one image data of the plurality of image data obtained by the image-data obtaining unit is not blank-sheet data, to establish a state in which a storage device stores one of the one image data and another image data, wherein said another image data is image data based on which the output device outputs an image equivalent or similar to an image output by the output device based on the one image data;
a second processing unit configured, when the one image data of the plurality of image data obtained by the image-data obtaining unit is the blank-sheet data and when each of the two image data respectively prior to and subsequent to the one image data successively is not the blank-sheet data, to establish a state in which the storage device stores output command data for commanding the output device to output a blank-sheet image as an image corresponding to the one image data; and
a non-output-command storing unit configured, when the one image data of the plurality of image data obtained by the image-data obtaining unit is the blank-sheet data and when one successive image data that is one of the two image data respectively prior to and subsequent to the one image data successively is the blank-sheet data, to establish a state in which the storage device stores a non-output command data for commanding the output device not to output the blank-sheet image as the image corresponding to the one image data.

12. A non-transitory computer-readable medium storing an image output program executable by a computer of an output device comprising an output unit configured to output an image based on one of a plurality of image data processed by an image-data processing device, the plurality of image data comprising one image data and two image data respectively prior to and subsequent to the one image data successively, the image output program being designed to cause the computer to function as:
a first output control unit configured, when the one image data of the plurality of image data processed by the image-data processing device is not blank-sheet data, to control the output unit to output an image based on the one image data;
a second output control unit configured, when the one image data of the plurality of image data processed by the image-data processing device is the blank-sheet data and when each of the two image data respectively prior to and subsequent to the one image data successively is not the blank-sheet data, to control the output unit to output a blank-sheet image as an image corresponding to the one image data; and
a third output control unit configured, when the one image data of the plurality of image data processed by the image-data processing device is the blank-sheet data and when one successive image data that is one of the two image data is the blank-sheet data, to control the output unit not to output the blank-sheet image as the image corresponding to the one image data.

13. The non-transitory computer-readable medium according to claim 12, wherein the second output control unit is configured to control the output unit to output the blank-sheet image as the image corresponding to the one image data, based on an output command data for controlling the output unit to output the image corresponding to the one image data.

14. The non-transitory computer-readable medium according to claim 13,
wherein the second output control unit is configured, when the one image data is the blank-sheet data, and the one successive image data successive to the one image data is not the blank-sheet data and when the image corresponding to the one image data and an image corresponding to the one successive image data are data to be output by the output unit at a time, to control the output unit to output the blank-sheet image based on the output command data and the image corresponding to the one successive image data at a time, and
wherein the second output control unit is configured, when the one image data is the blank-sheet data, and the one successive image data successive to the one image data is not the blank-sheet data and when the image corresponding to the one image data and the image corresponding to the one successive image data are data not to be output by the output unit at a time, to control the output unit not to output the blank-sheet image based on the output command data.

15. A non-transitory computer-readable medium storing an image processing program executable by a computer of an image-data processing device configured to process image data to be used for an output device configured to output an image, the image processing program being designed to cause the computer to function as:
an image-file obtaining unit configured to obtain a first image file comprising a plurality of image data respectively corresponding to a plurality of successive pages; and
an image-file storing unit configured to store a second image file into a storage device,
wherein the second image file comprises one of first image data of the plurality of image data of the first image file obtained by the image-file obtaining unit and another image data based on which the output device outputs an image equivalent or similar to an image output by the output device based on the first image data, wherein the first image data is not the blank-sheet data,
wherein the second image file further comprises: one of second image data of the plurality of image data of the first image file obtained by the image-file obtaining unit and output command data, wherein the second image data is the blank-sheet data, and image data successive to the second image data is not the blank-sheet data, and wherein the output command data is data based on which the output device outputs a blank-sheet image equivalent or similar to a blank-sheet image output by the output device based on the second image data, and
wherein the second image file does not comprise: third image data of the plurality of image data of the first image file obtained by the image-file obtaining unit or another output command data, wherein the third image data is the blank-sheet data, and image data successive to the third image data is the blank-sheet data, and wherein the said another output command data is data based on which the output device outputs a blank-sheet image equivalent or similar to a blank-sheet image output by the output device based on the third image data.
